(19) United States
(12) Patent Application Publication
(10) Pub. No.: US 2020/0174555 A1
(43) Pub. Date: Jun. 4, 2020

(54) DISPLAY DEVICE, DISPLAY METHOD, AND DISPLAY SYSTEM

(71) Applicant: KYOCERA Document Solutions Inc., Osaka (JP)

(72) Inventor: Takuya KOTSUJI, Osaka-shi (JP)

(73) Assignee: KYOCERA Document Solutions Inc., Osaka (JP)

(21) Appl. No.: 16/695,546

(22) Filed: Nov. 26, 2019

(30) Foreign Application Priority Data
Nov. 29, 2018 (JP) 2018-223303

(51) Int. Cl. G06F 3/01; G06T 7/70; G06F 3/16; G09G 5/32; G06T 7/90; G06T 11/00; G06F 17/24; G10L 15/22; H04N 1/40

(52) U.S. Cl. CPC G06F 3/011; G06T 7/70; G06F 3/167; G09G 5/32; G06T 7/90; G06T 2207/30196; G06F 17/243; G10L 15/22; H04N 1/40; G06T 2207/30176; G06T 11/001

(57) ABSTRACT

A display device includes a display section, a generating section, and a controller. The display section displays an image. The generating section generates a support image that defines a position of a character to be written on a sheet. The controller controls the display section so that the display section displays the support image according to the sheet.

### INCORPORATION BY REFERENCE

The present application claims priority under 35 U.S.C. § 119 to Japanese Patent Application No. 2018-223303, filed on Nov. 29, 2018. The contents of this application are incorporated herein by reference in their entirety.

### BACKGROUND

The present disclosure relates to a display device, a display method, and a display system.

In order to reduce mistakes in filing in a form such as an application form or a contract, a technique for displaying information helpful to a user in the vicinity of a text entry field in the form has been examined.

### SUMMARY

A display device according to an aspect of the present disclosure includes a display section, a generating section, and a controller. The display section displays an image. The generating section generates a support image that defines a position of a character to be written on a sheet. The controller controls the display section so that the display section displays the support image according to the sheet.

A display method according to an aspect of the present disclosure is a display method for a display device including a display section. The display method includes generating a support image that defines a position of a character to be written on a sheet, and controlling the display device so that the display section displays the support image according to the sheet.

A display system according to an aspect of the present disclosure is a display system including a display device, and an image forming apparatus. The display device includes a display section, a generating section, a controller, an imaging section, and a transmitting section. The display section displays an image. The generating section generates a support image that defines a position of a character to be written on a sheet. The controller controls the display section so that the display section displays the support image according to the sheet. The imaging section photographs the sheet on which the character is written, and generates image data indicating an image of the sheet. The transmitting section transmits the image data to the image forming apparatus. The image forming apparatus includes a receiving section, and an image forming section. The receiving section receives the image data. The image forming section forms an image based on the image data received by the receiving section.

### BRIEF DESCRIPTION OF THE DRAWINGS

FIG. 1 is a schematic diagram depicting a function of a display device according to an embodiment of the present disclosure.

FIG. 2 is an enlarged diagram of a support image displayed on a display section of the display device.

FIG. 3 is a block diagram depicting a configuration of the display device.

FIG. 4 illustrates a first support image in a first example.

FIG. 5A illustrates a function of a display device in the first example. FIG. 5B illustrates how a user handwrites characters using a support image.

FIG. 6A illustrates another function of the display device in the first example. FIG. 6B illustrates a second support image in the first example.

FIG. 7 is a flowchart depicting a handwriting assist process by the display device.

FIG. 8 is a flowchart depicting a first assist process in the first example.

FIG. 9 is a flowchart depicting a second assist process in a second example.

FIG. 10 illustrates how to change the size of a support image in the second example, and a display example of an alert message.

FIG. 11 illustrates a display example of a next character to be written in the second example.

FIG. 12 is a schematic diagram depicting a configuration of a display system according to a variation.

### DETAILED DESCRIPTION

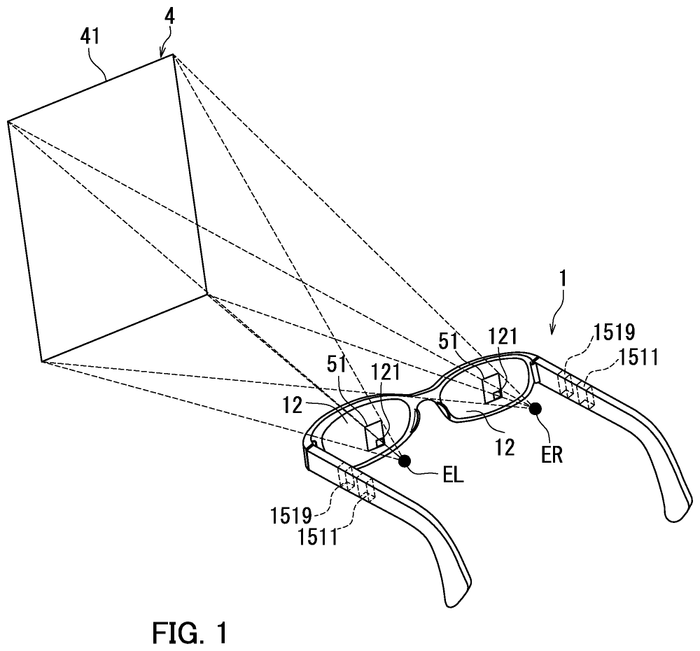

An embodiment of the present disclosure will hereinafter be described with reference to the accompanying drawings (FIGS. 1 to 12). Note that elements that are the same or equivalent are labelled with the same reference signs in the drawings and description thereof is not repeated.

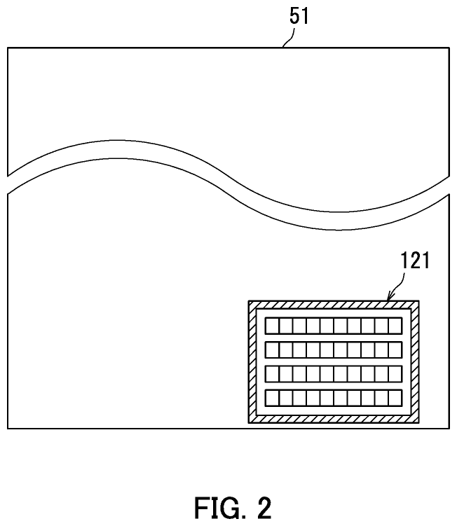

A schematic function of a display device 1 according to the present embodiment will first be described with reference to FIGS. 1 and 2. FIG. 1 schematically depicts the function of the display device 1. The display device 1 supports a user who performs handwriting on a sheet that is a recording medium. In the present embodiment, the sheet has a flat area that allows the user to handwrite thereon. Note that the sheet may include a spherical surface.

Examples of the sheet material include paper, cloth, rubber, and plastic. Examples of the display device 1 include augmented reality (AR) glasses, and a head mounted display (HMD).

As illustrated in FIG. 1, the display device 1 includes a display section 12, a generating section 1511, and a controller 1519.

The display section 12 displays an image. Specifically, the embodiment includes, as the display section 12, left and right (paired) display sections 12 that display at least a support image 121. In the present embodiment, the image generated by the generating section 1511 is projected on the display sections 12. The display sections 12 include their respective transparent (see-through) liquid-crystal displays that display a color image. However, each of the display sections 12 is not limited to the transparent liquid-crystal display. The display sections 12 may include respective organic electroluminescent (EL) displays.

The generating section 1511 generates the support image 121. The support image 121 defines the position of each character to be written on a paper sheet 4.

Specifically, the support image 121 is an image displayed according to the paper sheet 4, and indicates respective positions of handwritten characters per character. For example, the support image 121 is formed of a diagram including squares such as manuscript paper (called genkō yōshi in Japan). The controller 1519 causes each of the paired display sections 12 to display the support image 121 generated by the generating section 1511. Note that the paper sheet 4 is an example of a “sheet”.

The controller 1519 controls the display sections 12 so that the display sections 12 display the support image 121 according to the paper sheet 4. Specifically, the controller 1519 controls the display sections 12 so that each of the paired display sections 12 displays the support image 121 according to a predetermined area on the paper sheet 4.

The support image 121 is displayed in the position of the lower right corner of an outline 51, corresponding to an outline 41 of the paper sheet 4, projected on each of the display sections 12. This enables the user wearing the display device 1 to visually recognize the paper sheet 4 in the real world and the support image 121 through the display sections 12. Note that in the present embodiment, the “the real world” is an environment around the display device 1. An image captured by photographing the paper sheet 4 and the periphery of the paper sheet 4 is hereinafter referred to as a “surrounding image”.

FIG. 1 further illustrates a positional relationship of the display device 1 and the paper sheet 4 with eye positions of the user. That is, FIG. 1 illustrates a positional relationship of the paired display sections 12 of the display device 1 and the paper sheet 4 with the eye positions EL and ER of the user wearing the display device 1. The eye position EL represents the position of the left eye of the user. The eye position ER represents the position of the right eye of the user.

The outline 41 that is the periphery of the paper sheet 4 is projected, as the outline 51, on the display sections 12 of the display device 1. The support image 121 is further displayed on the display sections 12 such that the support image 121 is superimposed on each outline 51. In the present embodiment, the support image 121 is displayed in the lower right corner of each outline 51. The user visually recognizes, by both the eye positions EL and ER, a pair of outlines 51 and a pair of support images 121 superimposed thereon in the display sections 12.

FIG. 2 is an enlargement diagram of the support image 121 displayed on each display section 12 of the display device 1. As illustrated in FIG. 2, the support image 121 is displayed in the lower right corner of the outline 51 with the support image 121 superimposed on the paper sheet 4. This enables the user to handwrite 4 lines (rows) of characters that include 10 characters per line on the paper sheet 4 while viewing the paper sheet 4 on which the support image 121 is superimposed.

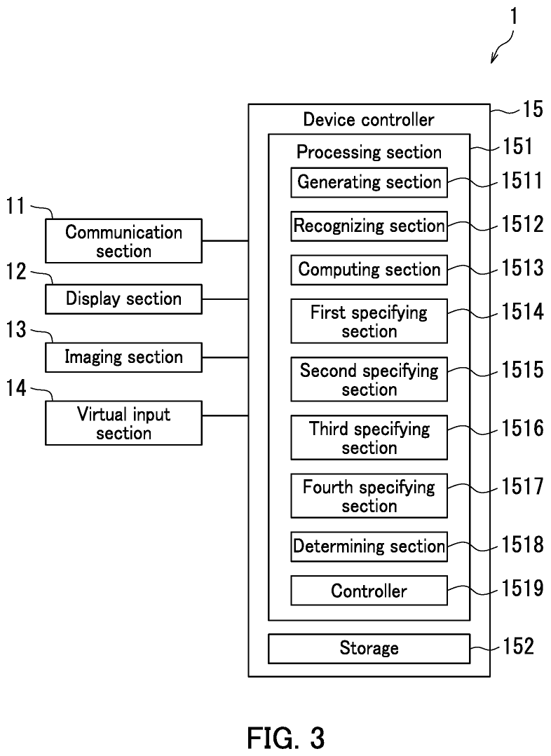

A configuration of the display device 1 will next be described in detail with reference to FIG. 3. FIG. 3 is a block diagram depicting a configuration of the display device 1. As illustrated in FIG. 3, the display device 1 includes a communication section 11, a display section 12, an imaging section 13, a virtual input section 14, and a device controller 15.

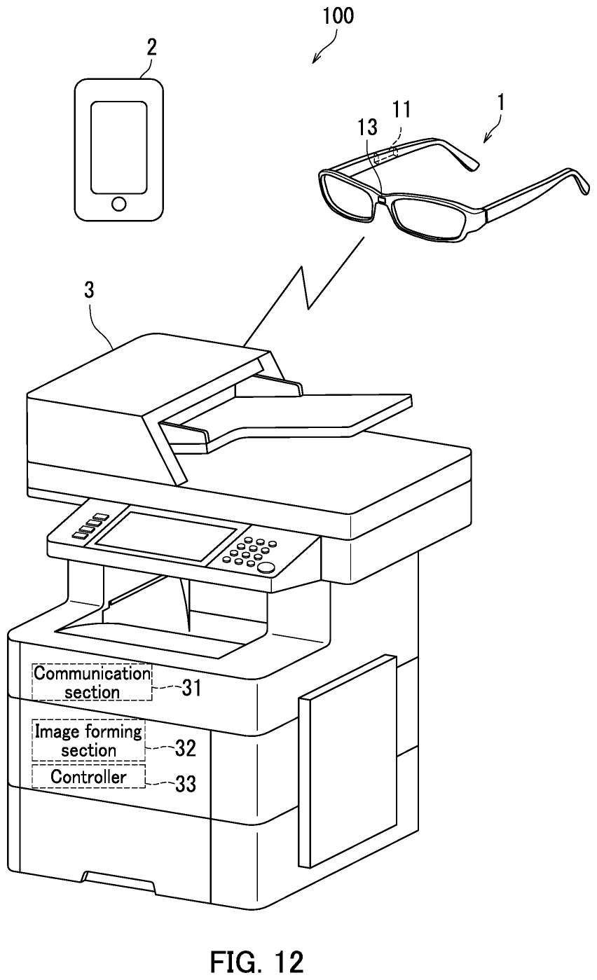

The communication section 11 transmits and receives various pieces of data with another electronic device according to an instruction of the device controller 15. Specifically, the communication section 11 receives voice data representing a voice from a communication terminal such as a smartphone. The communication section 11 further transmits image data to an image forming apparatus 3 to be described later with reference to FIG. 12. The image forming apparatus 3 is a color multifunction peripheral. The color multifunction peripheral is hereinafter also referred to a “multifunction peripheral (MFP)”. The communication section 11 is, for example a communication interface. Note that the communication section 11 is an example of a “second input section”.

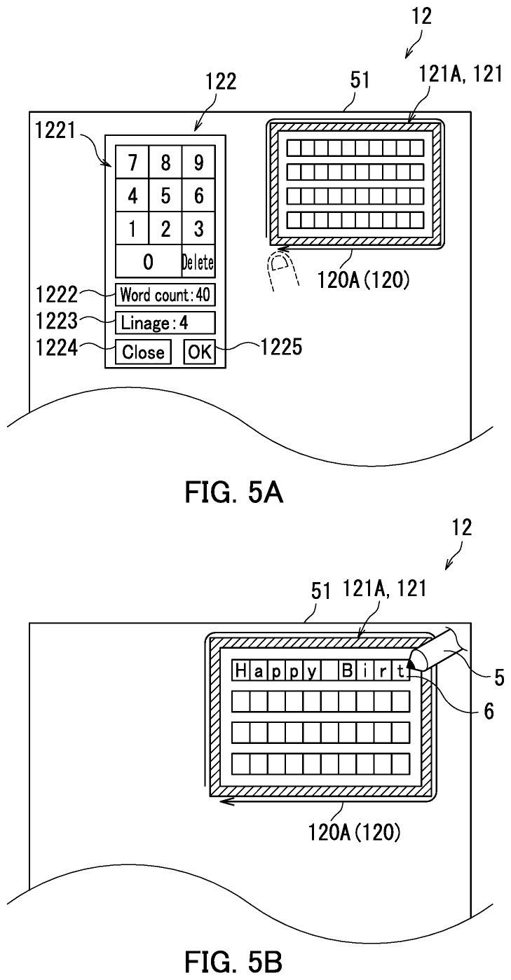

The display section 12 displays an image according to an instruction of the device controller 15. Specifically, the display section 12 displays the support image 121, and an on-screen virtual input 122 to be described later with reference to FIG. 5A.

The display section 12 displays, for example, the support image 121 projected from a projector (not shown) included in the device controller 15, and the on-screen virtual input 122. The display section 12 is a transparent display unit including a pair of lenses, and a pair of polarizing shutters. Here, the “transparent display unit” is a display unit that displays, while transmitting external light, a picture captured by the imaging section 13 and an image generated by the device controller 15. The polarizing shutters are individually affixed to entire surfaces of the lenses. Each of the polarizing shutters is composed of a liquid-crystal display device, and can be switched between an opened state in which the polarizing shutter transmits external light and a closed state in which the polarizing shutter does not transmit external light. Voltage applied to a liquid-crystal layer of each liquid-crystal display device is controlled, and thereby a corresponding polarizing shutter switches between the opened state and the closed state.

Note that the display section may be a nontransparent display unit. Here, the “nontransparent display unit” is a display unit that displays, without transmitting external light, a picture captured by the imaging section 13 and an image generated by the device controller 15.

The imaging section 13 photographs a paper sheet 4 to generate (capture) paper image data representing an image of the paper sheet 4. Specifically, according to an instruction of the device controller 15, the imaging section 13 photographs the paper sheet 4, and then generates the paper image data. Furthermore, according to an instruction of the device controller 15, the imaging section 13 photographs a finger moving on the paper sheet 4, and then generates finger image data representing an image of the finger. The imaging section 13 may photograph an area including the entire paper sheet 4 in photographing the finger. Alternatively, according to the instruction of the device controller 15, the imaging section 13 may photograph the paper sheet 4 and the surroundings of the paper sheet 4, and then generates surrounding image data also representing a surrounding image. Note that the paper image data are an example of “sheet image data”.

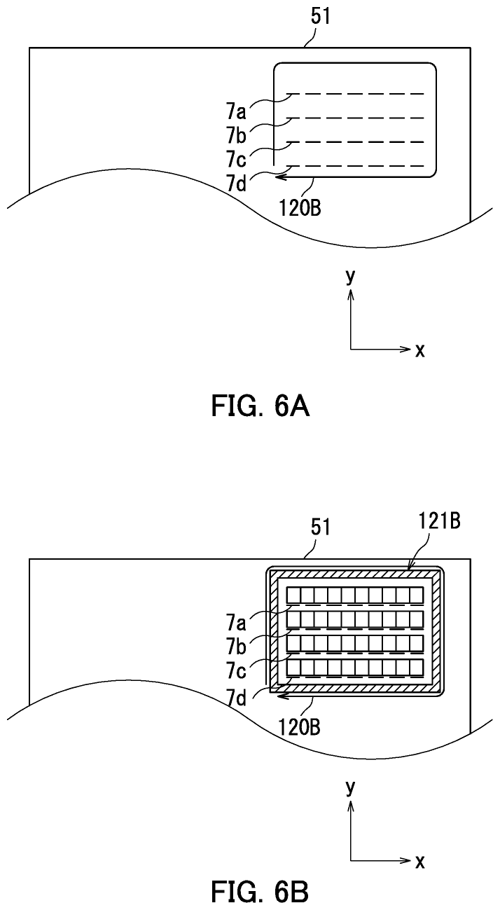

The paper image data are used by the device controller 15 in order to identify the area of the paper sheet 4. The paper image data are further used by the device controller 15 in order to determine whether or not the paper sheet 4 includes one or more support lines. The paper image data are also used by the device controller 15 in order to identify the color of the paper sheet 4. Here, the one or more “support lines” mean one or more lines depicted in a specific direction on the paper sheet 4. The support lines will be described later with reference to FIG. 6A.

The finger image data are used by the device controller 15 in order to identify the locus of a finger of a user. The finger image data are further used by the device controller 15 in order to specify the position of a next character to be written.

The surrounding image data are used by the device controller 15 in order to display the support image 121 on a nontransparent display unit according to the paper sheet 4.

The imaging section 13 is not an essential component of the display device 1. For example, capturing of an image by the imaging section 13 is unnecessary in the case where a positional relationship between the sheet 4 and the display device 1 is fixed, and the support image 121 is displayed in a specified position of the paper sheet 4.

Examples of the imaging section 13 include a charge coupled device (CCD) image sensor, and a complementary metal oxide semiconductor (CMOS) image sensor.

The virtual input section 14 receives an instruction based on an action of the user, or gesture. In the present embodiment, the virtual input section 14 receives an instruction from the user based on a gesture of a finger. The virtual input section 14 receives at least the number of characters. Here, the “number of characters” is a total number of characters to be handwritten.

The virtual input section 14 further receives the number of rows or columns of characters to be written. Here, the “number of rows” is the number of character strings arranged in a y-direction of handwritten text. The “number of columns” is the number of character strings aligned in an x-direction of handwritten text. The virtual input section 14 also receives an instruction on a designated area to be described later with reference to FIG. 5A. The “designated area” is an area that defines the display position of the support image 121 to be superimposed on the paper sheet 4. Note that the virtual input section 14 is an example of a “first input section”.

The device controller 15 controls respective operations of components constituting the display device 1 based on a control program. The device controller 15 includes a processing section 151, and storage 152. The processing section 151 is, for example a processor. The processor is, for example a central processing unit (CPU). The device controller 15 may further include a projection section (not shown) that projects the support image 121 and the on-screen virtual input 122 on the display section 12.

The processing section 151 executes the control program stored in the storage 152, thereby controlling the respective operations of the components constituting the display device 1. In the present embodiment, the processing section 151 causes the storage 152 to store therein voice data received by the communication section 11. The processing section 151 further recognizes characters from the voice represented by the voice data to generate text data representing the characters.

The storage 152 stores various pieces of data and the control program. The storage 152 includes at least one of devices, examples of which include read-only memory (ROM), random-access memory (RAM), and a solid-state drive (SSD). In the present embodiment, the storage 152 stores the voice data therein. The storage 152 further stores therein the text data representing the characters recognized by the processing section 151.

The processing section 151 includes the generating section 1511, a recognizing section 1512, a computing section 1513, a first specifying section 1514, a second specifying section 1515, a third specifying section 1516, a fourth specifying section 1517, a determining section 1518, and the controller 1519. In the present embodiment, the processing section 151 executes the control program stored in the storage 152, thereby realizing respective functions of the generating section 1511, the recognizing section 1512, the computing section 1513, the first specifying section 1514, the second specifying section 1515, the third specifying section 1516, the fourth specifying section 1517, the determining section 1518, and the controller 1519.

The generating section 1511 generates the support image 121 based on the number of characters and the number of the support lines. In the present embodiment, the generating section 1511 generates the support image 121 that defines respective positions of one or more characters, corresponding to the number of characters received from the user. The support image 121 generated by the generating section 1511 defines the respective positions of one or more characters, further corresponding to the number of rows or columns in addition to the number of characters received from the user. Alternatively, the generating section 1511 may generate the support image 121 corresponding to the number of characters counted, and the number of rows or columns computed. Specifically, the generating section 1511 may generate the support image 121 that defines respective positions of one or more characters, corresponding to the number of characters counted by the recognizing section 1512, and the number of rows or columns computed by the computing section 1513.

The generating section 1511 generates the support image 121 according to the prescribed area in the area of the paper sheet 4. Specifically, the generating section 1511 generates the support image 121 according to a partial area, of the paper sheet 4, defined by the locus of a finger of the user. In the present embodiment the color of the support image 121 generated by the generating section 1511 is “red”. The generating section 1511 further changes the color of the support image 121 to the color complementary to that of the paper sheet 4 in the case where the color of the support image 121 is determined to approximate the color of the image of the paper sheet 4. For example, in the case where the paper sheet 4 and the support image 121 are both “red” in color, the generating section 1511 changes the color of the support image 121 to “green” that is the color complementary to red. Changing the color of the support image 121 to the color complementary to that of the paper sheet 4 enables the user to visually recognize the respective positions of characters to be handwritten in a clearer manner. The generating section 1511 also generate the on-screen virtual input 122 to be described later with reference to FIG. 5A.

The recognizing section 1512 recognizes characters from a voice represented by the voice data. Specifically, the recognizing section 1512 recognizes the characters from the voice represented by the voice data obtained through the communication section 11 and the like. The recognizing section 1512 further counts the number of characters recognized.

The computing section 1513 computes the number of rows or columns based on the number of characters counted by the recognizing section 1512. Specifically, in the case where characters per row or column are set to “10 characters” in advance, every time the number of the characters being counted by the recognizing section 1512 increases by 10, the computing section 1513 increases the number of rows or columns by one, thereby computing the number of rows or columns.

The first specifying section 1514 specifies at least the area of the paper sheet 4 based on the paper image data. The first specifying section 1514 further determines whether or not one or more support lines depicted in a first direction exist based on the paper image data corresponding to the partial area of the paper sheet 4. Specifically, the first specifying section 1514 specifies one or more support lines depicted in the first direction based on the paper image data corresponding to the partial area of the paper sheet 4 designated by a designated area 120. The first specifying section 1514 then specifies the number of rows of a message to be handwritten based on the one or more support lines specified.

The second specifying section 1515 specifies the locus of a finger of the user based on the finger image data generated by the imaging section 13. For example, the second specifying section 1515 calculates, for each elapsed unit of time, a relative finger position on the paper sheet 4 from respective lengths of the outline 41 of the paper sheet 4 in the x- and y-directions based on the finger image data including the entire paper sheet 4, thereby specifying the locus of the finger of the user.

The third specifying section 1516 specifies the position of a next character to be written based on the finger image data, and the support image data representing the support image 121. Specifically, based on the finger image data and the support image data representing the support image 121, the third specifying section 1516 specifies the position of fingers of the user holding a pen, and the position of the next character to be written corresponding to the position of the fingers.

The fourth specifying section 1517 specifies the color of an image of the paper sheet 4, and the color of the support image 121 based on the paper image data, and the support image data representing the support image 121.

The determining section 1518 determines whether or not the color of the support image 121 approximates the color of the image of the paper sheet 4.

As described with reference to FIG. 1, the controller 1519 controls the display section 12 so that the support image 121 is displayed according to the paper sheet 4. The controller 1519 further controls the display section 12 based on text data stored in the storage 152 so that a next character to be written is displayed in the vicinity of an image, representing the position of the next character to be written, in the support image 121. Specifically, the controller 1519 controls the display section 12 so that a character specified by the third specifying section 1516 is displayed as the next character to be written. The controller 1519 also controls the display section 12 so that the on-screen virtual input 122 is displayed thereon. Alternatively, in the case of the nontransparent display section, the controller 1519 controls the display section 12 so that the display section 12 displays the support image 121 according to the paper sheet 4 in the surrounding image.

### First Example

A first example according to the present embodiment will next be described with reference to FIGS. 1 to 8.

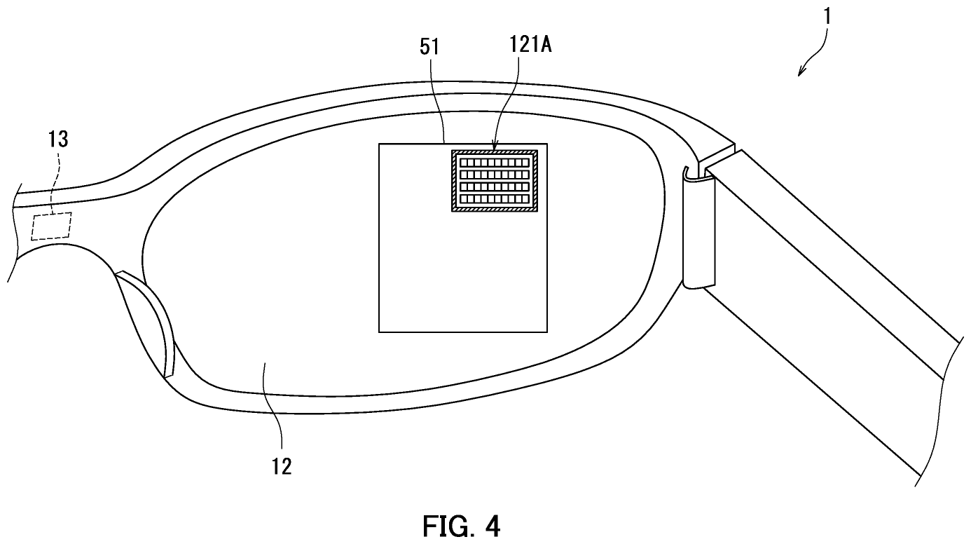

FIG. 4 illustrates a first support image 121A in the first example. As illustrated in FIG. 4, a display device 1 includes a display section 12, and an imaging section 13. The display section 12 displays the first support image 121A. The first example further enables a user to visually recognize an outline 51 projected as an outline 41 of a paper sheet 4 through the display section 12. That is, the user wearing the display device 1 visually recognizes the first support image 121A, which supports handwriting of the user, in an area corresponding to the upper right corner of the paper sheet 4.

As described above with reference to FIG. 3, the imaging section 13 generates paper image data, and finger image data. The imaging section 13 may further generate surrounding image data.

FIG. 5A illustrates a function of the display device 1 in the first example. FIG. 5A depicts an example of a situation viewed by the user wearing the display device 1. Specifically, FIG. 5A depicts the outline 51 as a projected image of the outline 41 of the paper sheet 4, and an image projected on a polarizing shutter of the display section 12. The image projected on the polarizing shutter of the display section 12 includes a designated area 120A, the first support image 121A, and an on-screen virtual input 122. Note that hereinafter, a designated area 120 is a generic name for the designated area 120A, and a designated area 120B. A support image 121 is also a generic name for the first support image 121A, a second support image 121B, and a third support image 121C.

The designated area 120 represents a display position of the first support image 121A that is set by the user to handwrite characters on the paper sheet 4. For example, a virtual input section 14 detects the movement of the user's finger sliding on the surface of the paper sheet 4, thereby determining the designated area 120. The designated area 120 designated by the user is displayed with the designated area 120 projected on the polarizing shutter of the display section 12. Such display projected on the polarizing shutter of the display section 12 is hereinafter referred to as “display in a projective manner”. For example, the designated area 120 is displayed in a projective manner by black lines.

A controller 1519 causes the display section 12 to display the designated area 121A in the position of the designated area 120 designated by the user.

The on-screen virtual input 122 is an on-screen image generated by a generating section 1511. The on-screen virtual input 122 is an on-screen image displayed in a projective manner in order to receive necessary information from the user. Specifically, the on-screen virtual input 122 includes a virtual keyboard 1221, a word count field 1222, a lineage field 1223, a close key 1224, and an OK key 1225.

The virtual keyboard 1221 receives numbers entered by the user.

The word count field 1222 receives the number of characters of the support image 121 entered by the user. The lineage field 1223 receives the number of rows of the support image 121 entered by the user.

The close key 1224 terminates the display of the on-screen virtual input 122 according to an operation of the close key 1224 by the user. The OK key 1225 determines, according to an operation of the OK key 1225 by the user, the number of characters received, and the number of rows received.

FIG. 5B illustrates how the user handwrites characters using the support image 121. Specifically, FIG. 5B illustrates a situation in which the user wearing the display device 1 handwrites characters on the paper sheet 4 with a pen 5 using the support image 121. As illustrated in FIG. 5B, the present example enables the user to handwrite characters one by one on the paper sheet 4 while viewing the paper sheet 4 on which the first support image 121A is superimposed.

FIG. 6A illustrates another function of the display device in the first example. As illustrated in FIG. 6A, the paper sheet 4 has four support lines 7a to 7d. Each of the four support lines 7a to 7d is a dashed line depicted in an x-direction. The four support lines 7a to 7d are arranged in a y-direction.

FIG. 6A further depicts the designated area 120B. The virtual input section 14 determines the designated area 120B based on the movement of a finger of the user. A first specifying section 1514 further specifies the number of rows of a message to be handwritten based on the number of the support lines included in the designated area 120. In the example of FIG. 6A, the number of rows of the message to be handwritten is “4”.

FIG. 6B illustrates the second support image 121B in the first example. When the user designates the designated area 120B, the generating section 1511 generates the support image 121 based on the number of characters and the number of rows. The generating section 1511 further determines the display position of the support image 121 based on the second support image 121B, and the position of the designated area 120B.

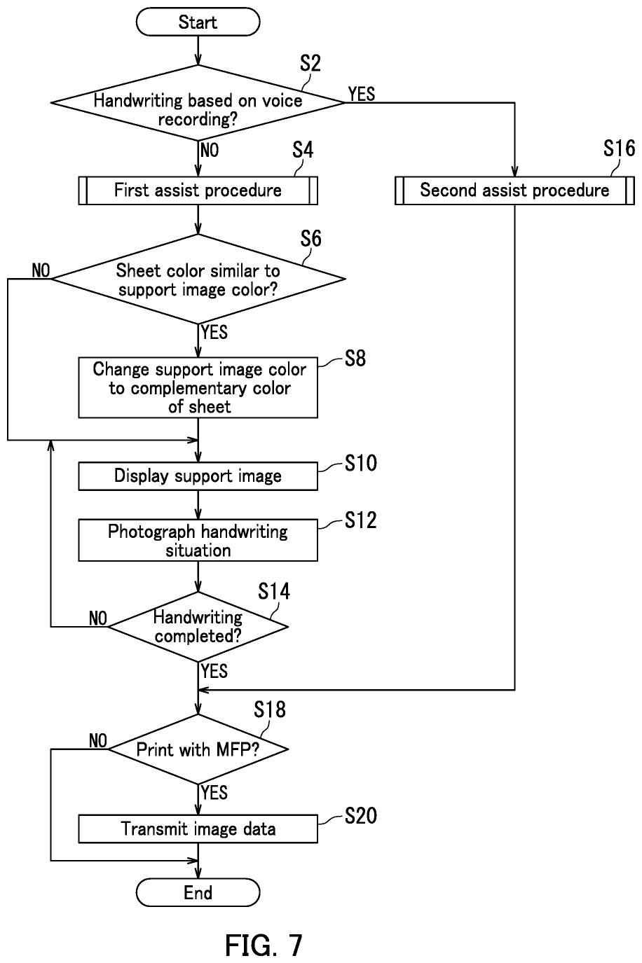

FIG. 7 is a flowchart depicting a handwriting assist process by the display device 1. The “handwriting assist process” is a process of displaying a prescribed support image 121 on the display section 12, thereby assisting the user who will handwrite on the paper sheet 4. The handwriting assist process includes steps S2 to S20 to be executed.

Step S2: a device controller 15 determines whether or not handwriting is based on voice recording. “Voice recording” means that voice data representing a voice are recorded in a playable manner. When the device controller 15 determines that the handwriting is based on the voice recording (YES at step S2), the process proceeds to step S16. When the device controller 15 determines that the handwriting is not based on the voice recording (NO at step S2), the process proceeds to step S4.

Step S4: the device controller 15 executes a first assist procedure (subroutine). The process then proceeds to step S6.

Step S6: a determining section 1518 determines whether or not the color of the support image 121 is similar to the color of the paper sheet 4. When the determining section 1518 determines that the color of the support image 121 is similar to the color of the paper sheet 4 (YES at step S6), the process proceeds to step S8. When the determining section 1518 determines that the color of the support image 121 is not similar to the color of the paper sheet 4 (NO at step S6), the process proceeds to step S10.

Step S8: the generating section 1511 changes the color of the support image 121 to the color complementary to that of the paper sheet 4. The process then proceeds to step S10.

Step S10: the display section 12 displays the support image 121 according to an instruction of the controller 1519. The process then proceeds to step S12.

Step S12: the imaging section 13 photographs the situation in which the user is handwriting characters (handwriting situation). The process then proceeds to step S14.

Step S14: the device controller 15 determines whether or not the user has completed handwriting the characters. When the device controller 15 determines that the user has completed handwriting the characters (YES at step S14), the process proceeds to step S18. When the device controller 15 determines that the user has not completed handwriting the characters (NO at step S14), the process returns to step S10.

Step S16: the device controller 15 executes a second assist procedure (subroutine). The process then proceeds to step S18.

Step S18: the device controller 15 determines whether or not handwritten characters are to be printed with an MFP based on an instruction from the user. When the device controller 15 determines that the handwritten characters are to be printed with the MFP (YES at step S18), the process proceeds to step S20. When the device controller 15 determines that the handwritten characters are not be printed with the MFP (NO at step S18), the process ends

Step S20: a communication section 11 transmits image data representing handwritten text to the MFP according to an instruction of the device controller 15. The process then ends.

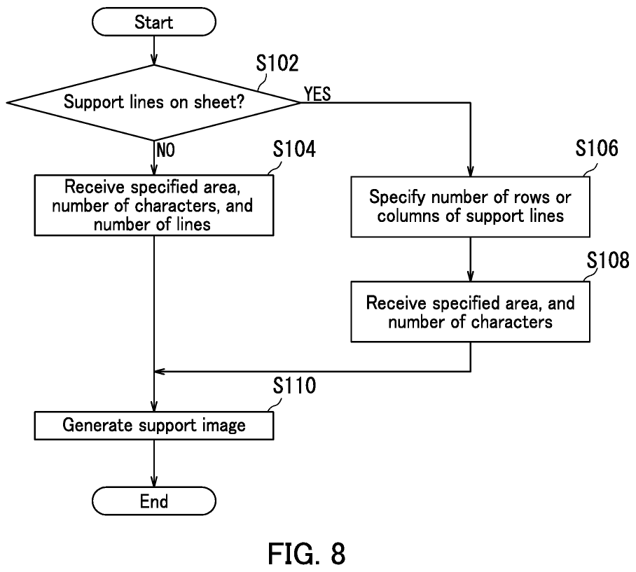

FIG. 8 is a flowchart of the “first assist procedure” in the handwriting assist process described above with reference to FIG. 7. The first assist procedure is a procedure for generating the support image 121 by using the support lines and the instruction from the user. The first assist procedure includes steps S102 to S110 to be executed.

Step S102: the first specifying section 1514 determines whether or not one or more support lines are present in the paper sheet 4. When the first specifying section 1514 determines that one or more support lines are present in the paper sheet 4 (YES at step S102), the procedure proceeds to step S106. When the first specifying section 1514 determines that one or more support lines are not present in the paper sheet 4 (NO at step S102), the procedure proceeds to step S104.

Step S104: the virtual input section 14 receives the designated area 120, the number of characters, and the number of rows from the user. The procedure then proceeds to step S110.

Step S106: the first specifying section 1514 specifies the number of rows or columns by the support lines on the paper sheet 4. The procedure then proceeds to step S108.

Step S108: the virtual input section 14 receives the designated area 120, and the number of characters from the user. The procedure then proceeds to step S110.

Step S110: the generating section 1511 generates the support image 121. The procedure then ends.

As stated above, the display device 1 in the first example enables the user to handwrite characters while viewing respective positions of the characters defined by the support image 121 displayed according to the paper sheet 4. It is therefore possible to prevent mistakes in the handwriting in the case where the user handwrites desired character strings in a prescribed area. Furthermore, handwriting on the paper sheet 4 on which support lines are provided in advance enables the user to omit input of the number of rows or columns.

### Second Example

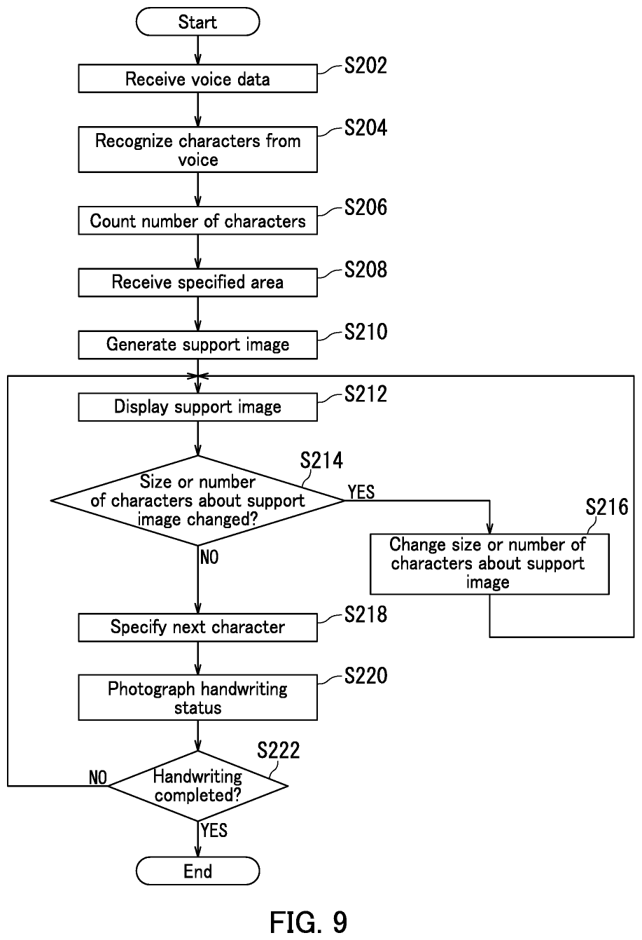

A second example according to the present embodiment will next be described with reference to FIGS. 3, and 9 to 11. FIG. 9 is a flowchart of the “second assist procedure” in the handwriting assist process described above with reference to FIG. 7. The second assist procedure is a procedure for generating the support image 121 by using a voice by voice recording. The second assist procedure includes steps S202 to S222 to be executed.

Step S202: the communication section 11 receives the voice data from a communication terminal. The procedure then proceeds to step S204.

Step S204: a recognizing section 1512 recognizes characters based on the voice represented by the voice data. The procedure then proceeds to step S206.

Step S206: the recognizing section 1512 counts the number of characters recognized.

The procedure then proceeds to step S208.

Step S208: the virtual input section 14 receives the designated area 120. The procedure then proceeds to step S210.

Step S210: the generating section 1511 generates the support image 121. The procedure then proceeds to step S212.

Step S212: the display section 12 displays the support image 121 according to an instruction of the controller 1519. The procedure then proceeds to step S214.

Step S214: the device controller 15 determines whether or not the number of characters or size of the support image 121 is to be changed according to an instruction from the user. When the device controller 15 determines that the number of characters or the size of the support image 121 is to be changed (YES at step S214), the procedure proceeds to step S216. When the device controller 15 determines that neither the number of characters nor the size of the support image 121 is to be changed (NO at step S214), the procedure proceeds to step S218.

Step S216: the generating section 1511 generates a support image 121 in which the number of characters or the size of the current support image 121 is changed. The procedure then proceeds to step S212.

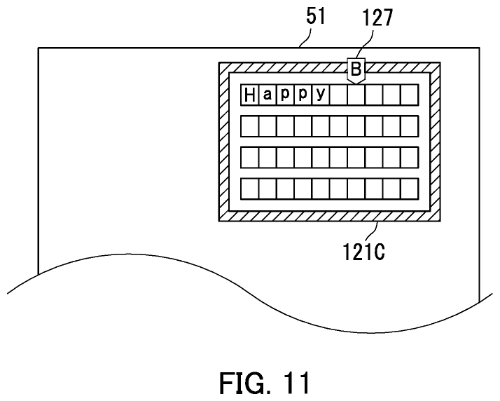

Step S218: the controller 1519 causes the display section 12 to display a next character 127 (FIG. 11) to be written, which has been specified by the first specifying section 1514. FIG. 11 will be described later. The procedure then proceeds to step S220.

Step S220: the imaging section 13 photographs a handwriting situation of the user. Specifically, the imaging section 13 photographs the position of a finger of the user to generate the finger image data. The procedure then proceeds to step S222.

Step S222: the device controller 15 determines whether or not the user has completed handwriting the characters. When the device controller 15 determines that the user has completed handwriting the characters (YES at step S222), the procedure ends. When the device controller 15 determines that the user has not completed handwriting the characters (NO at step S222), the procedure returns to step S212.

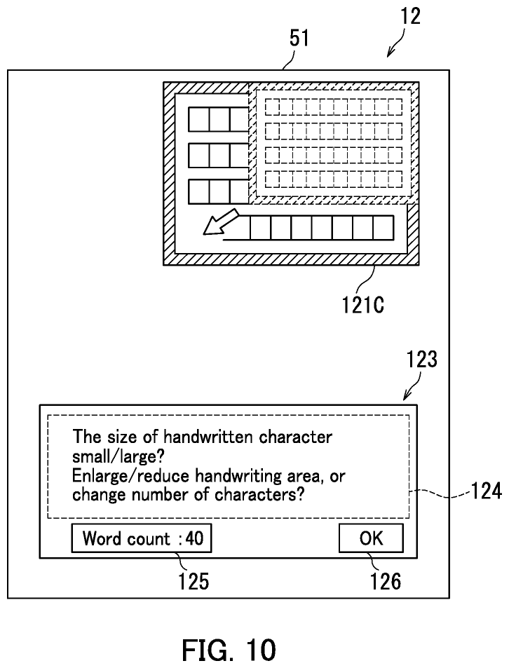

FIG. 10 illustrates how the size of the support image is changed. Here, the support image relates to “the task of step S214, and the task of step S216” in the second example described with reference to FIG. 9. FIG. 10 also illustrates a display example of an alert message. As illustrated in FIG. 10, the display section 12 displays the third support image 121C, and an on-screen alert message 123.

In the present example, the virtual input section 14 enlarges or reduces the size of the third support image 121C based on the instruction received from the user.

The on-screen alert message 123 contains an alert message 124, a word count field 125, and an OK button 126. The alert message 124 calls attention of the user to checking the size of the third support image 121C displayed by the display section 12. The word count field 125 receives the number of characters to be changed. The OK button 126 allows the third support image 121C to be generated based on the number of characters in the word count field 125.

FIG. 11 illustrates a display example of the next character to be written relating to “the task of step S218” in the second example described with reference to FIG. 9. As illustrated in FIG. 1I, the display section 12 displays the character “B” outside a corresponding input square in the frame of the third support image 121C. The character “B” is the next character 127 to be written.

As stated above, the display device 1 in the second example enables the user to handwrite characters by using the voice by the voice recording. That is, the characters are recognized from the voice by the voice recording, and one of the recognized characters is displayed in the vicinity of the input square of the next character to be written. It is therefore possible to prevent mistakes in the handwriting in the case where the user handwrites each of characters from the voice by the voice recording in a corresponding prescribed area.

(Variations)

A display system 100 according to a variation will next be described with reference to FIGS. 1 to 3, and 12. FIG. 12 is a schematic diagram depicting a configuration of the display system 100 according to the variation. As illustrated in FIG. 12, the display system 100 includes a display device 1, a terminal device 2, and an image forming apparatus 3.

The terminal device 2 is, for example a smartphone having a voice recording function. The terminal device 2 transmits voice data to the display device 1.

A communication section 11 of the display device 1 receives the voice data from the terminal device 2. A generating section 1511 generates a support image 121 based on the voice data. A display section 12 displays the support image 121 according to an instruction of a device controller 15, thereby supporting handwriting of a user. An imaging section 13 of the display device 1 photographs a paper sheet 4 on which characters are handwritten by the user, and then generates image data. The communication section 11 of the display device 1 further transmits the image data to the image forming apparatus 3. Note that the communication section 11 is an example of a “transmitting section”. The display device 1 is also not limited to the case where the voice data is obtained from the terminal device 2. For example, the display device 1 may obtain voice data through a recording medium on which the voice data are stored.

The image forming apparatus 3 includes a communication section 31, an image forming section 32, and a controller 33. The communication section 31 receives the image data transmitted from the display device 1 according to an instruction of the controller 33. The image forming section 32 generates an image according to an instruction of the controller 33. The controller 33 controls respective operations of components constituting the image forming apparatus 3. Note that the communication section 31 is an example of a “receiving section”.

As stated above, the display device 1 in the variation enables the user to handwrite while preventing mistakes in the handwriting, based on the voice data received from the terminal device 2. It is further possible to print the handwritten content on a remote image forming apparatus 3.

As stated above, the embodiment of the present disclosure has been described with reference to the accompany drawings. However, the present disclosure is not limited to the above embodiment and may be implemented in various manners within a scope not departing from the gist of the present disclosure (see (1) to (4) below, for example). The drawings schematically illustrate main elements of configuration to facilitate understanding thereof. Aspects of the elements of configuration illustrated in the drawings, such as thickness, length, number and interval, may differ in practice for the sake of convenience for drawing preparation. Furthermore, aspects of the elements of configuration illustrated in the above embodiment, such as shape, and dimension, are one example and are not particularly limited. The elements of configuration may be variously altered within a scope not substantially departing from the configuration of the present disclosure.

(1) Although, in the example described in the embodiment of the present disclosure, the support image 121 is composed of the diagram including the squares such as manuscript paper, the form of the support image is not limited to this. For example, the support image may be composed of only one or more horizontal or vertical lines for defining respective positions of characters to be handwritten.

(2) Although, in the example described with reference to FIG. 6A, the number of rows is computed by using the support lines depicted in the paper sheet 4, the present disclosure is not limited to this. For example, in the case where handwritten writing is in the periphery of the paper sheet 4, the support image 121 may be generated by computing respective sizes of characters, space between lines, or the number of rows from the writing. It may also be possible to cause the display section 12 to display the support image 121.

(3) Although, in the example described with reference to FIG. 1, the support image 121 generated on the paper sheet 4 is rectangular, the present disclosure is not limited to this. For example, a trapezoid-shaped support image may be generated in each of diagonal directions on a colored paper sheet for collection of writing.

(4) The present disclosure may further be realized as a display method including steps corresponding to the characteristic configuration means of the display device according to an aspect of the present disclosure, or as a control program including the steps. The program may also be distributed via a recording medium such as a CD-ROM or a transmission medium such as a communication network.

What is claimed is:

1. A display device, comprising
a display section configured to display an image,
a generating section configured to generate a support image that defines a position of a character to be written on a sheet, and
a controller configured to control the display section so that the display section displays the support image according to the sheet.

2. The display device according to claim 1, further comprising
a first input section configured to receive at least a number of characters, wherein
the generating section generates the support image that defines respective positions of one or more characters corresponding to the number of characters received.

3. The display device according to claim 2, wherein
the first input section receives a number of rows or columns, the rows or the columns allowing characters to be written therealong and,
the generating section generates the support image according to the number of characters received, and the number of rows or columns.

4. The display device according to claim 1, further comprising
an imaging section configured to photograph the sheet to generate sheet image data representing a sheet image, and
a first specifying section configured to specify at least an area of the sheet based on the sheet image data, wherein
the generating section generates the support image according to a prescribed area of the area of the sheet, and
the display section displays at least the support image.

5. The display device according to claim 4, wherein
the imaging section shoots a finger moving on the sheet and generates finger image data representing a finger image,
the display device further comprises a second specifying section configured to specify a locus of the finger based on the finger image data, and
the generating section generates the support image according to a partial area of the area of the sheet defined by the locus of the finger.

6. The display device according to claim 5, wherein
the first specifying section specifies one or more support lines depicted in a first direction based on the sheet image data corresponding to the partial area of the area of the sheet, and
the generating section generates the support image based on the number of characters, and the number of support lines.

7. The display device according to claim 5, further comprising
a second input configured to receive voice data representing a voice,
a recognizing section configured to recognize the character from the voice represented by the voice data, and to count a number of the character recognized, and
a computing section configured to compute the number of rows or columns based on the number of characters counted, wherein
the generating section generates the support image according to the number of characters counted, and the number of rows or columns computed.

8. The display device according to claim 7, further comprising
a storage configured to store text data representing the character recognized by the recognizing section, and
a third specifying section configured to specify a position of a next character to be written based on the finger image data and the support image data representing the support image, wherein
the controller controls the display section so that the next character to be written is displayed in the vicinity of an image representing a position of the next character to be written in the support image based on the text data stored in the storage.

9. The display device according to claim 3, further comprising
a fourth specifying section configured to specify respective colors of the sheet and the support image based on the sheet image data and the support image data representing the support image, and
a determining section configured to determine whether or not the color of the support image approximates the color of the sheet image, wherein
the generating section changes the color of the support image to a color complementary to the color of the sheet image when it is determined that the color of the support image approximates the color of the sheet image.

10. The display device according to claim 1, further comprising
an imaging section configured to photograph the sheet and a periphery of the sheet, and to generate surrounding image data representing a surrounding image, wherein
the display section is a nontransparent display, and
the controller controls the display section so that the display section displays the support image according to the sheet in the surrounding image.

11. A display method for a display device including a display section, comprising
generating a support image that defines a position of a character to be written on a sheet, and
controlling the display section so that the display section displays the support image according to the sheet.

12. A display system, comprising
a display device, and an image forming apparatus, wherein
the display device includes
a display section configured to display an image,
a generating section configured to generate a support image that defines a position of a character to be written on a sheet,
a controller configured to control the display section so that the display section displays the support image according to the sheet,
an imaging section configured to photograph the sheet on which the character is written, and to generate image data indicating an image of the sheet, and
a transmission section configured to transmit the image data to the image forming apparatus, and
the image forming apparatus includes
a receiving section configured to receive the image data, and
an image forming section configured to generate an image based on the image data received.
